(19) United States
(12) Patent Application Publication
(10) Pub. No.: US 2014/0324891 A1
(43) Pub. Date: Oct. 30, 2014

(54) APPARATUS AND METHOD FOR MANAGING APPLICATION ERROR

(71) Applicant: Samsung Electronics Co., Ltd., Gyeonggi-do (KR)

(72) Inventors: Kyung-Joong KIM, Seoul (KR); Young-Seop Lee, Gyeonggi-do (KR); Yoong-Hee Lee, Incheon (KR)

(73) Assignee: Samsung Electronics Co., Ltd., Gyeonggi-do (KR)

(21) Appl. No.: 14/154,644

(22) Filed: Jan. 14, 2014

(30) Foreign Application Priority Data
Apr. 29, 2013 (KR) 10-2013-0047549

(51) Int. Cl. G06F 11/07; G06F 17/30

(52) U.S. Cl. CPC G06F 11/0781; G06F 17/30699
USPC 707/754

(57) ABSTRACT

Methods and apparatus are provided for managing an application error. Error record information on at least one application in which an error has occurred is collected from at least one portable device. The collected error record information is stored in a table that maps error information of each application. An application list provision request is received from a portable device. At least one application to be filtered from an application list is identified based on the error information of each application mapped in the table. The application is filtered from the application list to generate a filtered application list. The filtered application list is provided to the portable device.

### PRIORITY

This application claims priority under 35 U.S.C. §119(a) to Korean Application Serial No. 10-2013-0047549, which was filed in the Korean Intellectual Property Office on Apr. 29, 2013, the entire content of which is incorporated herein by reference.

### BACKGROUND OF THE INVENTION

1. Field of the Invention

The present invention relates generally to an apparatus and a method for managing an application error, and more particularly, to an apparatus and a method for managing an application error so as to exclude an application in which an error has occurred, when providing various applications.

2. Description of the Related Art

Applications are mounted in and are provided for service in a portable device, such as a mobile phone. Before being mounted in the portable device, it must be determined whether an application meets a quality assurance standard of a telecommunication company. Additionally, in order to produce applications such as a game, a messenger, utilities, or the like, and to provide services of these applications in the portable device, execution and operation stability problems must be checked. The various applications go through an individual quality assurance test for quality assurance.

The applications are tested and corrected many times by a developer, and then are distributed by an operator or an application server. The application server provides a list of various applications to the portable device of a user who is interested in purchasing an application. The list of the applications is displayed on the portable device, and the user may select and purchase a desired application.

In general, all applications that are operated based on a middleware platform, other than the middleware platform in a portable device, are included and serviced in the portable device with various specifications. Even when the applications have been tested and corrected many times before being mounted in the portable device, an application error may not be entirely solved through a quality assurance test, or the like.

The error may be in the application itself or may be generated by a quality problem of the middleware platform. It is difficult to identify a cause of a problem generated by the quality problem of the middleware platform, and an error occurrence frequency is high.

A problem may also be generated by an environmental distinctiveness in a process of supplying applications such as network environment, or the like. In a current application quality verification system, it is difficult to fundamentally solve the problem every time the problem occurs. Accordingly, a developer should collect error information on what kind of error is generated in an application in order correct the occurred error.

An operator of an application server or the like simply provides a list of various applications corresponding to specifications of the portable device to the portable device. However, the operator fails to systemically manage the causes and types of the errors of the erroneous application.

### SUMMARY OF THE INVENTION

The present invention has been made to address at least the above problems and/or disadvantages and to provide at least the advantages described below. Accordingly, an aspect of the present invention provides an apparatus and a method for systemically managing an application in which an error has occurred.

Another aspect of the present invention provides an apparatus and a method for managing an application error in order to prevent an application in which an error has occurred from being exposed to the portable device.

In accordance with another aspect of the present invention, a method is provided for managing an application error in an application server. Error record information on at least one application in which an error has occurred is collected from at least one portable device. The collected error record information is stored in a table that maps error information of each application. An application list provision request is received from a portable device. At least one application to be filtered from an application list is identified based on the error information of each application mapped in the table. The application is filtered from the application list to generate a filtered application list. The filtered application list is provided to the portable device.

In accordance with another aspect of the present invention, a method is provided for managing an application error in a portable device. Error record information is stored according to execution of at least one application. The error record information on the at least one application is transmitted to a server that manages error information of each application. An application list provision request is transmitted to the server. An application list that was filtered at the server based on the error information of each application, is received in response to the application list provision request.

In accordance with another aspect of the present invention, an application server is provided for managing an application error. The application server includes an application error management unit that collects error record information on at least one application in which an error has occurred from at least one portable device. The application server also includes an error information database that stores the collected error record information in a table that maps error information of each application. The application server additionally includes an application filtering unit that identifies at least one application to be filtered from an application list based on the error information of each application mapped in the table when an application list provision request has been received from a portable device, and that filters the application from the application list to generate a filtered application list. The application server further includes an application provider that provides the filtered application list to the portable device.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a schematic diagram illustrating a construction of a system for managing an application error, according to an embodiment of the present invention;

FIG. 2 is a block diagram illustrating the inside of a portable device illustrated in the FIG. 1, according to an embodiment of the present invention;

FIG. 3 is a flowchart illustrating a process of transmitting and receiving a message between a portable device and an application server, according to an embodiment of the present invention;

FIG. 4 is a flowchart illustrating a process of managing an application error in an application server, according to an embodiment of the present invention; and

FIG. 5 illustrates an error information table, according to an embodiment of the present invention.

### DETAILED DESCRIPTION OF EMBODIMENTS OF THE PRESENT INVENTION

Embodiments of the present invention are described in detail more with reference to the accompanying drawings. The same or similar components may be designated by similar reference numerals although they are illustrated in different drawings. Detailed descriptions of constructions or processes known in the art may be omitted to avoid obscuring the subject matter of the present invention.

While terms including ordinal numbers, such as “first” and “second,” etc., may be used to describe various components, such components are not limited by the above terms. The terms are used merely to distinguish an element from the other elements. For example, a first element could be termed a second element, and similarly, a second element could be also termed a first element without departing from the scope of the present invention. As used herein, the term “and/or” includes any and all combinations of one or more of the associated listed items.

The terms used in this application are for the purpose of describing particular embodiments only and are not intended to be limiting of the invention. As used herein, the singular forms are intended to include the plural forms as well, unless the context clearly indicates otherwise. Terms such as “include” and/or “have” may be construed to denote a certain characteristic, number, step, operation, constituent element, component or a combination thereof, but may not be construed to exclude the existence of or a possibility of the addition of one or more other characteristics, numbers, steps, operations, constituent elements, components or combinations thereof.

Unless defined otherwise, all terms used herein have the same meaning as commonly understood by those of skill in the art. Terms defined in a generally used dictionary are to be interpreted to have meanings equal to the contextual meanings in the relevant field of art, and are not to be interpreted to have ideal or excessively formal meanings unless clearly defined in the present specification.

Embodiments of the present invention provide a method of systematically managing an application error. Specifically, in embodiments of the present invention, information on an application in which an error has occurred is collected from a plurality of portable devices to make a table that maps error information of each application. Further, in embodiments of the present invention, when a portable device requests provisioning of a list of applications, a list of applications corresponding to the portable device with reference to the table is provided to the portable device. Accordingly, it is possible to prevent the application in which an error has occurred from being exposed to the portable device, and to enable a stable display and distribution of applications.

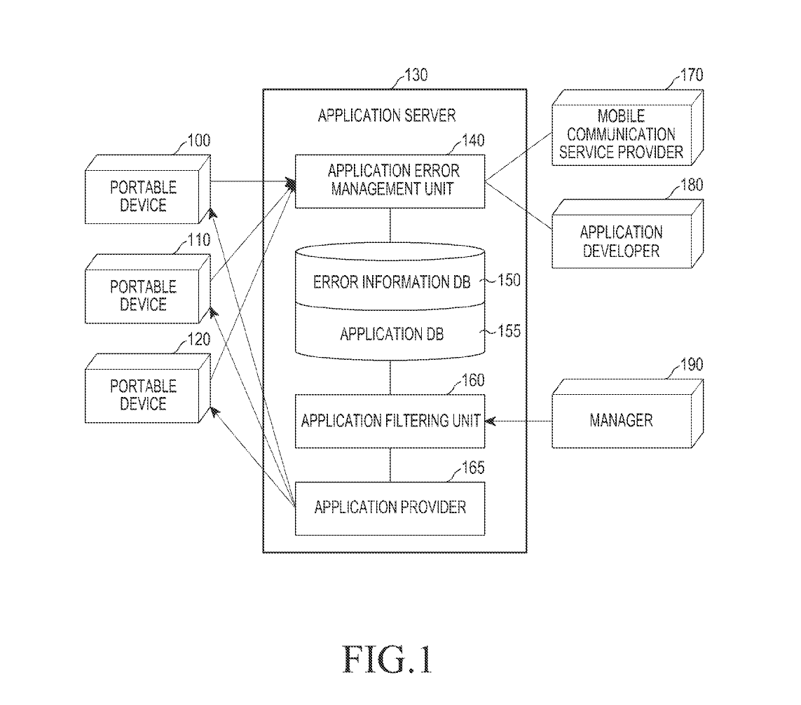

FIG. 1 is a schematic diagram illustrating the construction of a system for managing an application error, according to an embodiment of the present invention. As shown in FIG. 1, a system for managing an application error includes one or more portable devices 100, 110, and 120, an application server 130, a mobile communication service provider 170, an application developer (development company) 180, and a manager 190.

The portable device 100 loads and displays a list of applications which can be purchased and downloaded by accessing the application server 130, and performs operations such as purchase, login, search, and the like. The portable device 100 is equipped with a client that requests the list of applications from the application server 130 and purchases and downloads a desired application.

When an error has occurred while an application is executed, the portable device 100 generates and stores information on an error record for the application, which includes, for example, a type of error, and a content of error. The error record information represents a kind of error that occurs in n application.

Since the type of application errors which usually occurs in the portable device 100 including the application is also changed according to the type of the portable device, there is a correlation between information of the portable device and the type of error. Therefore, the error record information for the application may also include information of the portable device. The error record information is periodically or non-periodically transmitted to the application server 130.

The portable device 100 may be embodied as a smart phone, a mobile phone, a game device, a Television (TV), a display device, a vehicle-head unit, a laptop, a tablet Personal Computer (PC), a Personal Media Player (PMP), a Personal Digital Assistants (PDA), or the like. The portable device 100 may be implemented as a pocket-size portable mobile terminal having a portable terminal function, and a mobile terminal function, and a wireless communication function.

The application server 130 includes an application error management unit 140, an error information DataBase (DB) 150, an application DB 155, an application filtering unit 160, and an application provider 165. The application server 130 determines the applications, from among various applications, which the application server 130 will show to the portable devices 100, 110, and 120 according to a predetermined policy. In addition, the application server 130 provides a list of applications corresponding to the predetermined policy to the portable devices 100, 110, and 120, and provides a web environment required to purchase and download the applications.

The application error management unit 140 collects error record information of each application transmitted from each portable device 100, 110, and 120, and then stores the collected error record information in the error information DB 150. The application error management unit 140 periodically or non-periodically stores the collected error record information in log form in the error information DB 150. The application error management unit 140 statistically processes and arranges a type of error and a content of error for each application, item by item. Specifically, the application error management unit 140 may count the number of times an error has occurred, an error severity according to the number of times an error has occurred, or the like, for each application based on the statistically processed and arranged information.

Further, the application error management unit 140 consistently collects the error record information during a predetermined period, and may manage the error information of each application based on an application in which an error has occurred and information of the portable device, item by item. The predetermined period may be determined according to a request for an application developer, or the like.

The application error management unit 140 may not only store the error information in the error information database (DB) 150 but also report the error information to the mobile communication service provider 170 and the application developer (development company) 180. As a result, the application developer (development company) 180 can easily discover and modify application errors, and the mobile communication service provider 170 can provide a smooth application service.

The error information DB 150 stores a table that maps error information according to each application. A predetermined error information table in the error information DB 150 is implemented such that an application ID, a name of an application, a number of times by which an error has occurred, relative importance, information of the portable device, or the like, are arranged in a table form.

The application DB 155 stores applications developed through the application developer (development company) 180. FIG. 1 corresponds to an embodiment of the present invention in which the error information DB 150 is implemented in the application server 130. However, the error information DB 150 may exist outside of and be separated from the application server 130. Further, the application DB 155 may exist outside of the application server 130.

The application filtering unit 160 loads a list of basic applications from the application DB 155, according to a request to provide the list of applications from each of the portable devices 100, 110, and 120. Further, the application filtering unit 160 filters applications corresponding to the portable devices 100, 110, and 120 in the list of basic applications with reference to the error information DB 150. Specifically, the application filtering unit 160 determines a filtering condition with reference to the error information DB 150 and selects an application to be filtered for each of the portable devices 100, 110, and 120 according to the filtering condition. The filtering condition refers to a condition for grading each application according to the number of times an error has occurred, an error severity, or the like, and then filtering-out an application having a grade higher than and equal to a predetermined threshold.

The application provider 165 provides the list of applications to the portable devices 100, 110, and 120 so as to enable display and purchase of applications stored in the application DB 155. Specifically, the application provider 165 shows applications that can be downloaded and used from the portable device 100 connected to the application server 130. More specifically, according to an embodiment of the present invention, the application provider 165 provides a list of applications filtered for each of the portable devices 100, 110, and 120 to the portable devices 100, 110, and 120.

When the portable device 100 has made a request to provide an application list, a list of the applications filtered according to the portable device 100 is provided to the portable device 100 that has made the request. The application provider 165 may configure and output a Graphical User Interface (GUI) so that each of the portable device 100, 110, and 120 can request a list of applications and download a desired application. The application provider 165 shows a list of applications except for applications in which many errors have occurred, using a filtering function through the GUI.

The manager 190 refers to an operator having highest access privileges that can control a filtering condition by accessing the application server 130. The manager 190 having the highest access privileges is a user having a privilege that can cancel restrictions made by the application developer (development company) 180, and can access the application server 130 through a separately implemented manager site. The manager 190 may directly add a filtering condition, by itself, in addition to the filtering condition made based on the error information on applications provided by the portable devices 100, 110, and 120. For example, applications that should only be distributed to users over 18 years of age in a specific nation may be unconditionally filtered, or applications that belong to a specific category, e.g., a game, or the like may be filtered.

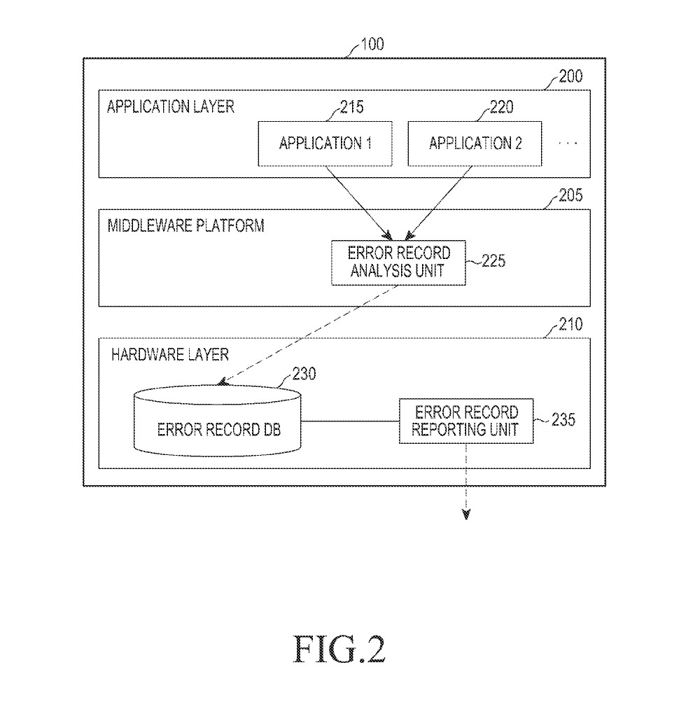

Hereinafter, operations of the portable device, among elements of a system managing an application error in which functions described above are implemented, is described with reference to FIG. 2. Since constructions and operations of the portable devices 100, 110, and 120 for managing an application error, according to an embodiment of the present invention, are similar to each other, elements of only one portable device 100 and operations thereof will be described as an example, with reference to FIG. 2.

FIG. 2 is a block diagram illustrating the inside of a portable device illustrated in the FIG. 1, according to an embodiment of the present invention. Referring to FIG. 2, the portable device 100 includes an application layer 200, a middleware platform 205, and a hardware layer 210.

The application layer 200 executes application 1 215 and application 2 220 on the middleware platform 205.

The middleware platform 205 provides an application program interface that can execute an application program. Various applications are developed according to a function Application Program Interface (API) standard, which is defined by the middleware platform 205 of the portable device 100 so that services of the various applications can be provided in the portable device 100. These applications may generate an error by the applications themselves or due to problems such as the platform, or the like. When an application error has occurred, an error record analysis unit 255 analyzes the error record for the application. Errors may occur in various forms due to the service environment, an internal problem, or the like. Therefore, according to an embodiment of the present invention, the error record analysis unit 255 configures an error record having a type (e.g., code) of one of various errors from a network, a storage unit, GUI, a platform, or the like, so that the application server 130 can identify the kind of error and the application in which the error has occurred.

The hardware layer 210 is a layer in which physical hardware exists and includes an error record DB 230 for storing the error record generated by the error record analysis unit 255, and an error record reporting unit 235 for reporting the error record to the application server 130.

The error record DB 230 arranges and stores error record information generated by the error record analysis unit 225, item by item. The error record DB 230 is implemented in a storage unit of the portable device 100. For example, a type (code) of an error, a content of an error, or the like, in an application, is stored. A name of an application in which an error has occurred, a location of error occurrence, time of error occurrence, and information on the portable device 100 in which an application error has occurred, may also be stored together.

The error record reporting unit 235 may transmit the error record information stored in the error record DB 120 according to a predetermined period, or may non-periodically transmit the error record information according to a request from the application server 130. For example, the error record reporting unit 235 transmits the error record information according to a designated transmission period policy by checking a period designated by the application server 130, e.g., transmission every 6 hours, transmission every 24 hours, or the like. Further, the error record information may be transmitted when there is a request from the application server 130.

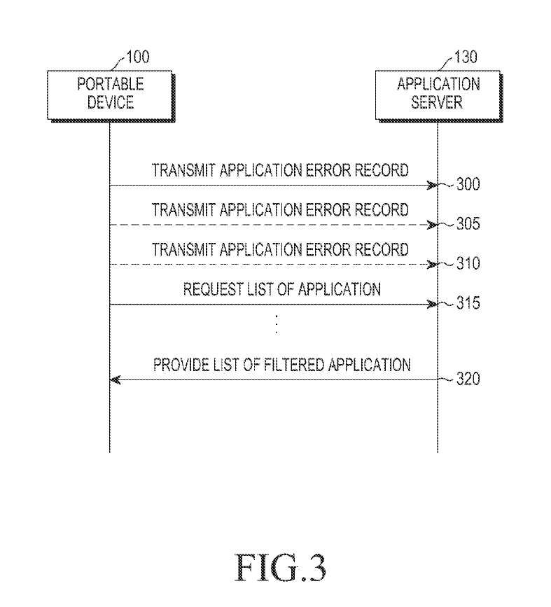

FIG. 3 is a flowchart illustrating a process of transmitting and receiving a message between a portable device and an application server, according to an embodiment of the present invention. Operations between the portable device 100 and the application server 130 are described with reference to FIG. 3.

Referring to FIG. 3, when an error has occurred while an application that has been downloaded is operated, the portable device 100 transmits an error record for the application, in steps 300 to 310. Whenever an application error has occurred, the error record may be transmitted to the application server 130. When there is a plurality of applications in which an error has occurred, the portable device 100 may store an error record for the plurality of applications in a log form, and then transmit the error record in log form according to the predetermined period or non-periodically. Further, although the embodiment of the present invention illustrated in FIG. 3 corresponds to a case in which an error record is transmitted before a request for a list of applications is transmitted, the error record may be transmitted according to the predetermined period or non-periodically. Therefore, the time point for transmission of the error record can be changed.

When the application error record has been received, the application server 130 statistically processes application errors using the error record and then stores the application error. In order to output the list of applications on a screen, the application device 100 transmits a request for a list of applications to the application server 130, in step 315. The request for the list of applications includes information on the portable device 100 transmitting the request.

In response, the application server 130 provides a list of filtered applications to the portable device 100, which requested the list of applications, in step 320. The list of the filtered applications corresponds to a list obtained by filtering-out applications in which an error has occurred and applications corresponding to information on the portable device 100, e.g., a model of the portable device 100 from a list of basic applications. The application server 130 may exclude either all applications in which an error has occurred or only applications in which an error has occurred more than a predetermined number of times, according to an embodiment of the present invention. The application server 130 identifies an application to be excluded with reference to a table mapping the application error information.

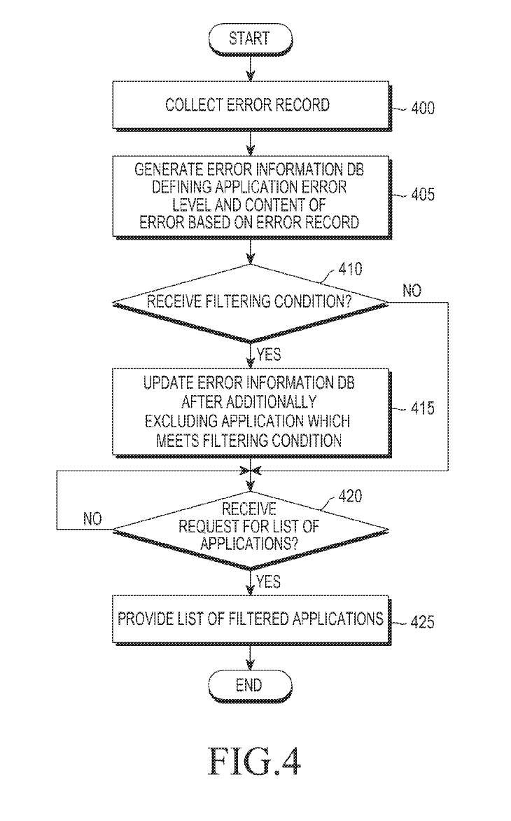

FIG. 4 is a flowchart illustrating a process of managing an application error in an application server, according to an embodiment of the present invention. Specific operations of the application server 130 for providing the list of the filtered applications is described with reference to FIG. 4.

Referring to FIG. 4, the application server 130 collects an error record for an application from one or more portable devices 100, 110, and 120, in step 400. In step 405, the application server 130 generates the error information DB 150 defining an application error level and the content of an error based on the error record. Specifically, the application server 130 stores the collected error record in a table that classifies and stores error severity levels according to the number of times errors have occurred in each application.

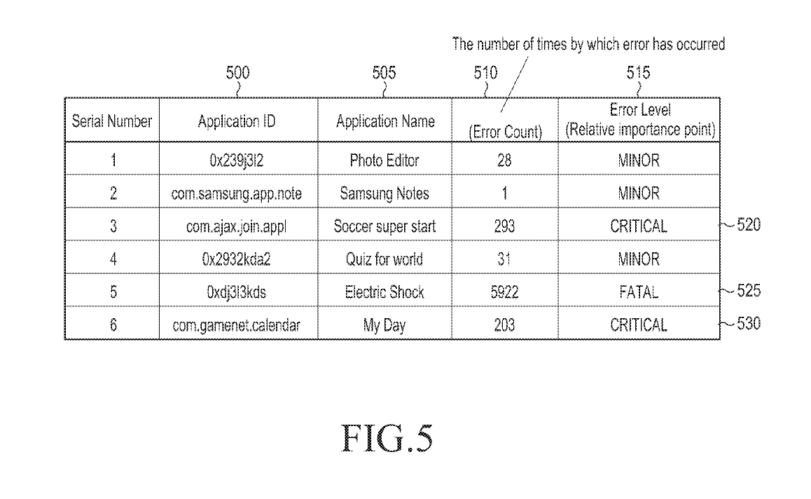

FIG. 5 illustrates a table stored in the error information DB 150, according to an embodiment of the present invention. Referring to FIG. 5, the application server 130 stores error record information in the form of a table that maps error information of each application based on the collected error record information. Specifically, error record information collected from the portable devices 100, 110, and 120 includes at least one of a name of an application in which an error occurs, a location of error occurrence, a time of error occurrence, and information on the portable device 100 in which an error has occurred in addition to a type (code) of error, and a content of error in an application.

The table of FIG. 5 arranges application IDs 500, application names 505, the number of times an error has occurred 510, an error severity 515 levels defined according to the number of times the error has occurred, item by item. Referring to FIG. 5, the application server 130 counts the number of times errors have occurred in each application and determines error severity levels according to the number of times the error has occurred. For example, an error severity C (e.g., ‘MINOR’) may be given to a case in which the number of times the error has occurred is within a first threshold number of times, an error severity B (e.g. ‘CRITICAL’) may be given to a case in which the number of times the error has occurred exceeds the first threshold number of times and is within a second threshold number of times, and an error severity A (e.g., ‘FATAL’) may be given to a case in which the number of times the error has occurred exceeds the second threshold number of times.

When the error severity level is ‘CRITICAL’ 520 and 530 or ‘FATAL’ 525, the application server 130 excludes an application having that error severity level from a list of basic applications to be provided to the portable device 100. Therefore, in the portable device 100, an application with a high error severity level is not exposed and a more stable application can be provided to a user.

While an embodiment of the present invention has been described in which an application is filtered according to an error severity level, a table additionally including information of a portable device, e.g., a model level of the portable device, which enables an application to be filtered according to the information of the portable device, may be implemented. For example, when a model level of the portable device belongs to a highest level, a list of all applications may be exposed. When the model level of the portable device belongs to a lowest level, a list of applications, excluding applications that are not supported by the performance of the portable device, may be exposed.

Accordingly, the application server 130 may determine that an application is to be filtered from the list of basic applications based on the error severity and information on the portable device, and may exclude that application.

Further, although an embodiment of the present invention has been described in which an error severity is determined according to the number of times by which an error has occurred, it is also possible to implement a configuration in which the error severity is set based on the type of error in the application. For example, it may be assumed that the error severity level A corresponds to a case in which a grave problem for use occurs, such as a case in which an application is forcibly terminated or the power of a device is forced off while the application is executed, the error severity level B corresponds to a case in which a problem for use occurs, for example, some of the applications main functions do not normally operate, and the error severity level C corresponds to a case in which auxiliary functions of an application do not normally operate. Accordingly, for the error severity level A, even when the number of times by which an error has occurred is small, the error may be fatal to the portable device. Therefore, the application server 130 may determine error severity by assigning a weighted value to the number of times by which an error has occurred according to the type of error.

Referring again to FIG. 4, after the error information DB is generated as described above, the application server 130 determines whether a filtering condition is received from the manager 190, in step 410. The filtering condition received from the manager 190 is input through a separate UI. For example, the filtering condition may include application use age limits, a specific application limit in a specific nation, or the like. Therefore, since it is possible to adjust the filtering condition through a manager site, the application filtering condition can be set to meet requirements as needed.

When the filtering condition has been received, the application server 130 updates the error information DB 150 after excluding an application satisfying the filtering condition, in step 415. In contrast, when the filtering condition is not received, the application server 130 proceeds to step 420. In step 420, the application server 130 determines whether a request for a list of applications is received from the portable device 100. Information of the portable device 100 is loaded in the request for the application list.

When the request for the list of applications has been received, the application server 130 detects information of the portable device 100 according to the request for the list of applications and provides the list of the filtered applications in the list of basic applications to the portable device 100 with reference to the error information DB 150 and the information of the portable device 100, in step 425. Specifically, the application server 130 identifies an application that should not be exposed, based on error information of each application in the error information DB 150 and the information of the portable device 100.

According to embodiments of the present invention, a user collects error records of several applications provided from various portable devices so that an application in which an error has occurred can be systematically managed. Further, an application distribution company or a developing company can automatically filter-out an application in which an error has occurred, so as to have a positive effect on the stability of the application server and a supply of the application.

Further, according to embodiments of the present invention, the portable device can automatically transmit the error record information of an application in which an error has occurred to the application server. Therefore, embodiments of the present invention enable an application server to prevent an application in which an error has occurred, from being exposed to the portable device, so as to enable a more stable display and distribution of applications.

It may be appreciated that the embodiments of the present invention can be implemented in software, hardware, or a combination thereof. Any such software may be stored, for example, in a volatile or non-volatile storage device such as a Read Only Memory (ROM), a memory such as a Random Access Memory (RAM), a memory chip, a memory device, or a memory Integrated Circuit (IC), or a recordable optical or magnetic medium such as a Compact Disc (CD), a Digital Versatile Disc (DVD), a magnetic disk, or a magnetic tape, regardless of its ability to be erased or its ability to be re-recorded. It can be also appreciated that the memory included in the mobile terminal is one example of machine-readable device suitable for storing a program including instructions that are executed by a processor device to thereby implement embodiments of the present invention. Therefore, embodiments of the present invention provide a program including codes for implementing a system or method claimed in any claim of the accompanying claims and a machine-readable device for storing such a program. Moreover, such a program as described above can be electronically transferred through an arbitrary medium such as a communication signal transferred through cable or wireless connection, and embodiments of the present invention include equivalent subject matter.

The portable device can receive the program from a program providing apparatus connected to the device, wirelessly or through a wire, and store the received program. The program providing apparatus may include a memory for storing a program, a communication unit for performing wired or wireless communication, and a controller.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method of managing an application error in an application server, the method comprising the steps of:
collecting error record information on at least one application in which an error has occurred from at least one portable device;
storing the collected error record information in a table that maps error information of each application;
receiving an application list provision request from a portable device;
identifying at least one application to be filtered from an application list based on the error information of each application mapped in the table;
filtering the application from the application list to generate a filtered application list; and
providing the filtered application list to the portable device.

2. The method of claim 1, wherein the error record information comprises at least one of a type of the error, a content of the error, a name of an application in which the error has occurred, a location of an error occurrence, a time of the error occurrence, and information on a portable device in which the error has occurred.

3. The method of claim 1, wherein storing the collected error record information comprises classifying and storing an error severity level according to a number of times an error has occurred.

4. The method of claim 3, wherein filtering the application comprises excluding the application that has an error security level higher than or equal to a predetermined level.

5. The method of claim 1, further comprising:
detecting model information of the portable device from the application list provision request; and
identifying the application to be filtered according to the model information of the portable device.

6. The method of claim 1, further comprising:
receiving a filtering condition from a manager of the application sever; and
identifying the application to be filtered according to the received filtering condition.

7. The method of claim 1, wherein the table comprises application IDs, names of each application, a number of times an error has occurred, and an error severity according to the number of times the error has occurred, arranged item by item.

8. A method of managing an application error in a portable device, the method comprising the steps of:
storing error record information according to execution of at least one application;
transmitting the error record information on the at least one application to a server that manages error information of each application;
transmitting an application list provision request to the server; and
receiving a application list that was filtered at the server based on the error information of each application, in response to the application list provision request.

9. The method of claim 8, wherein the error record information comprises at least one of a type of an error, a content of the error, a name of an application in which the error has occurred, a location of an error occurrence, a time of the error occurrence, and information on the portable device in which the error has occurred.

10. The method of claim 8, wherein the application list provision request comprises information on the portable device, which is referenced when the application list is filtered.

11. The method of claim 8, wherein the application list is obtained by excluding one or more applications having an error security level higher than or equal to a predetermined level from the application list, the error security level being classified according to a number of times an error has occurred in each application.

12. An application server for managing an application error, the application server comprising:
an application error management unit that collects error record information on at least one application in which an error has occurred from at least one portable device;
an error information database that stores the collected error record information in a table that maps error information of each application;
an application filtering unit that identifies at least one application to be filtered from an application list based on the error information of each application mapped in the table when an application list provision request has been received from a portable device, and that filters the application from the application list to generate a filtered application list; and
an application provider that provides the filtered application list to the portable device.

13. The application server of claim 12, wherein the error record information comprises at least one of a type of the error, a content of the error, a name of an application in which the error has occurred, a location of an error occurrence, a time of the error occurrence, and information on the portable device in which the error has occurred.

14. The application server of claim 12, wherein the application error management unit classifies error severity levels according to a number of times an error has occurred in each application based on the collected error record information, and stores the classified error severity levels in the error information database.

15. The application server of claim 14, wherein the application filtering unit excludes the application that has an error security level higher than or equal to a predetermined level, from the basic application list.

16. The application server of claim 14, wherein the application filtering unit detects model information of the portable device from the application list provision request, and identifies the application to be filtered according to the model information of the portable device.

17. The application server of claim 12, wherein the table comprises application IDs, names of each application, a number of times an error has occurred, and an error severity according to the number of times the error has occurred, arranged item by item.
